(19) United States
(12) Patent Application Publication
(10) Pub. No.: US 2012/0043766 A1
(43) Pub. Date: Feb. 23, 2012

(54) HOOD LATCH WITH THEFT PROTECTION FEATURE

(76) Inventors: Kurt E. Nurmi, Macomb, MI (US); John F. Reelhorn, Pickerington, OH (US); Rogelio Terrazas, Chihuahua (MX)

(21) Appl. No.: 12/861,506

(22) Filed: Aug. 23, 2010

(51) Int. Cl. E05C 19/12

(52) U.S. Cl. 292/126; 292/127

(57) ABSTRACT

A latch assembly is provided, the latch assembly having: a fork bolt pivotally secured to the latch assembly for movement between an unlatched position and a latched position; a detent lever pivotally secured to the latch assembly for movement between an engaged position and a disengaged position, wherein the fork bolt is prevented from moving toward the unlatched position from the latched position when the detent lever is in the engaged position; a frame, the frame having a striker opening and a first opening; and a secondary lever pivotally mounted to the latch assembly for movement between a first position, wherein a hasp of the secondary lever is positioned over the striker opening and a second position wherein the hasp is not positioned over the striker opening and wherein a feature of the secondary lever blocks access to the first opening when the secondary lever is in the first position and wherein the feature of the secondary lever does not block access to the first opening when the secondary lever is in the second position.

### BACKGROUND

Exemplary embodiments of the present invention relate to vehicle latch assemblies and, more particularly to a vehicle latch with a theft prevention feature.

A vehicle frequently includes displaceable panels such as doors, hood, trunk lid, hatch and the like which are affixed for hinged or sliding engagement with a host vehicle body. Cooperating systems of latches and strikers are typically provided to ensure that such panels remain secured in their fully closed position when the panel is closed.

A vehicle latch typically includes a fork bolt that is pivoted between an unlatched position and a primary latched position when a movable panel of the vehicle is closed to latch the movable panel in the closed position. The fork bolt is typically held in the primary latched position by a detent lever that pivots between an engaged position and a disengaged position. The detent lever is spring biased into the engaged position and thus, holds the fork bolt in the primary latched position when in the engaged position and releases the fork bolt when it is moved to the disengaged position so that the door, hood, trunk lid, hatch and the like can be opened.

The fork bolt is pivoted to the primary latched position by a striker attached to, for example, an associated movable panel when the movable panel is closed. Once in the primary latched position, the detent lever engages the fork bolt to ensure the assembly remains latched. A release cable is secured to the detent lever in order to move the detent lever to the disengaged position such that the fork bolt may move to the unlatched position. In some applications, it is desirable to provide access to the detent lever such that the release cable may be secured to the detent lever. However, access to the detent lever may compromise the security of the latch assembly.

Accordingly, it is desirable to provide a latch assembly wherein undesirable access to detent lever is prevented such that the fork bolt cannot be moved to the unlatched position.

### SUMMARY OF THE INVENTION

In accordance with an exemplary embodiment of the invention, a latch assembly is provided, the vehicle latch assembly having: a fork bolt pivotally secured to the latch assembly for movement between an unlatched position and a latched position; a detent lever pivotally secured to the latch assembly for movement between an engaged position and a disengaged position, wherein the fork bolt is prevented from moving toward the unlatched position from the latched position when the detent lever is in the engaged position; a frame, the frame having a striker opening and a first opening; and a secondary lever pivotally mounted to the latch assembly for movement between a first position, wherein a hasp of the secondary lever is positioned over the striker opening and a second position wherein the hasp is not positioned over the striker opening and wherein a feature of the secondary lever blocks access to the first opening when the secondary lever is in the first position and wherein the feature of the secondary lever does not block access to the first opening when the secondary lever is in the second position.

In another exemplary embodiment, a hood latch assembly in combination with a hood striker is provided, the latch assembly having: a frame having a striker opening and a first opening formed therein; a fork bolt pivotally secured to the latch assembly proximate to the striker opening for movement between an unlatched position and a latched position, the fork bolt having an opening configured to engage the hood striker when the hood striker is inserted into the striker opening and the fork bolt is in the unlatched position; a detent lever pivotally secured to the latch assembly for movement between an engaged position and a disengaged position, wherein the fork bolt is prevented from moving toward the unlatched position from the latched position when the detent lever is in the engaged position, wherein the detent lever is coupled to a release cable, the release cable being configured to move the detent lever from the engaged position to the disengaged position; and a secondary lever pivotally mounted to the latch assembly for movement between a first position, wherein a hasp of the secondary lever is positioned over the striker opening and a second position wherein the hasp is not positioned over the striker opening, wherein a feature of the secondary lever blocks access to the first opening when the secondary lever is in the first position and wherein the feature of the secondary lever does not block access to the first opening when the secondary lever is in the second position.

In another exemplary embodiment, a method of limiting access to a detent lever of a vehicle latch assembly, the method comprising: pivotally securing a fork bolt to a first side of a frame of the latch assembly for movement between an unlatched position and a latched position; pivotally securing a detent lever to the first side of the frame of the latch assembly for movement between an engaged position and a disengaged position, wherein the fork bolt is prevented from moving toward the unlatched position when the detent lever is in the engaged position; pivotally securing a secondary lever to a second opposite side of the frame of the latch assembly for movement between a first position, wherein a hasp of the secondary lever is positioned over a striker opening of the latch assembly and a second position wherein the hasp is not positioned over the striker opening, wherein a feature of the secondary lever blocks access to a first opening when the secondary lever is in the first position and wherein the feature of the secondary lever does not block access to the first opening when the secondary lever is in the second position; and securing a release cable to the detent lever on the first side of the latch assembly by using the first opening when the secondary lever is in the second position.

Additional features and advantages of the various aspects of exemplary embodiments of the present invention will become more readily apparent from the following detailed description in conjunction with the drawings wherein like reference numerals refer to corresponding parts in the several views.

### BRIEF DESCRIPTION OF THE DRAWINGS

FIG. 1 is a perspective view illustrating a latch assembly in accordance with an exemplary embodiment of the present invention in an unlatched position wherein a striker is not engaged by the fork bolt;

FIG. 2 is another perspective view illustrating a latch assembly of FIG. 1 in unlatched position;

FIG. 3 is an enlarged perspective view illustrating the latch assembly of FIGS. 1 and 2;

FIG. 4 is an enlarged side view illustrating the latch assembly of FIGS. 1 and 2;

FIG. 5 is an enlarged side view illustrating of the latch assembly in a latched position wherein the fork bolt has engaged a striker; and

FIG. 6 is a perspective view of the latch assembly in a latched position.

Although the drawings represent varied embodiments and features of the present invention, the drawings are not necessarily to scale and certain features may be exaggerated in order to illustrate and explain exemplary embodiments the present invention. The exemplification set forth herein illustrates several aspects of the invention, in one form, and such exemplification is not to be construed as limiting the scope of the invention in any manner.

### DETAILED DESCRIPTION OF EXEMPLARY EMBODIMENTS

Exemplary embodiments of the present invention relate to a vehicle latch assembly and in one non-limiting exemplary embodiment a hood latch assembly having a secondary lever with a feature that blocks access to an opening in the latch assembly when the secondary lever is in a first position and wherein the feature of the secondary lever does not block access to the opening when the secondary lever is in the second position.

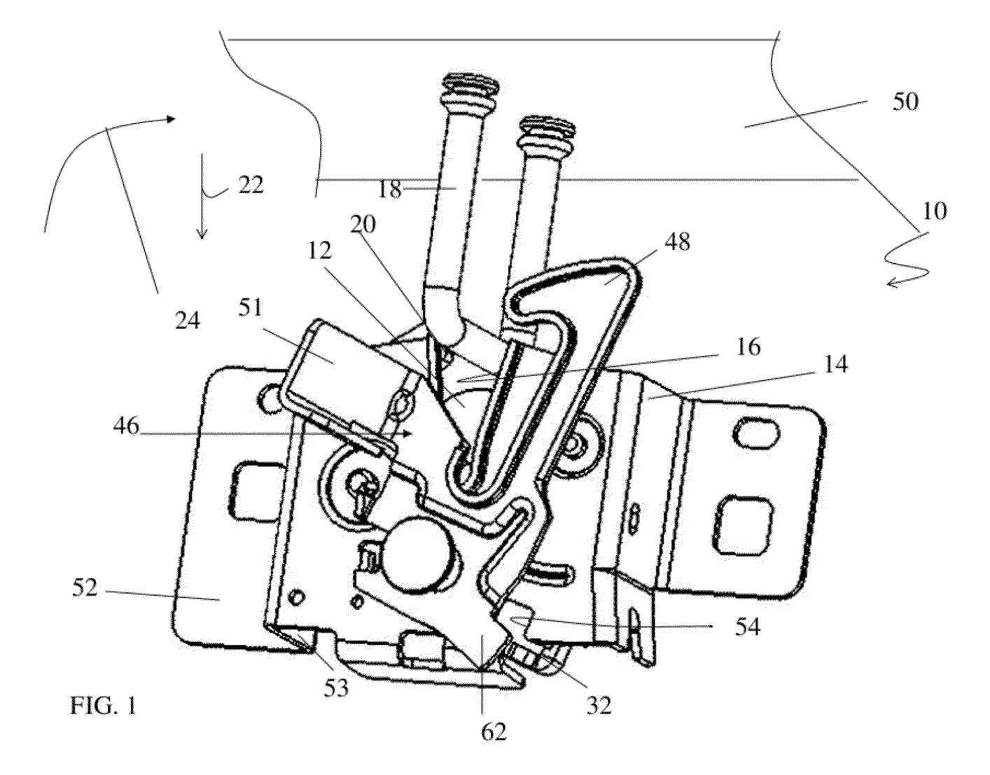

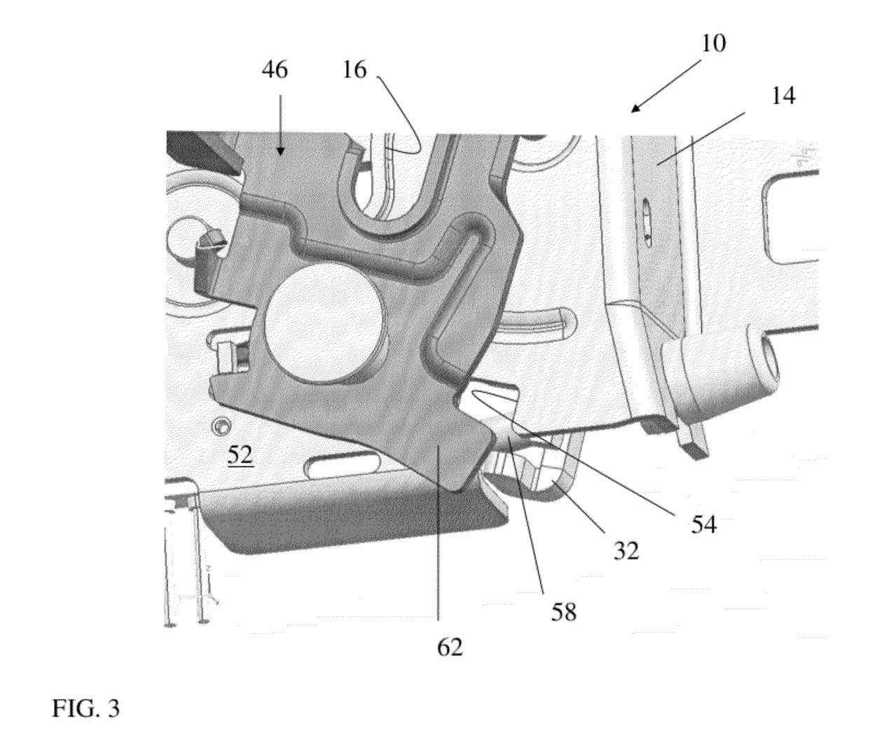

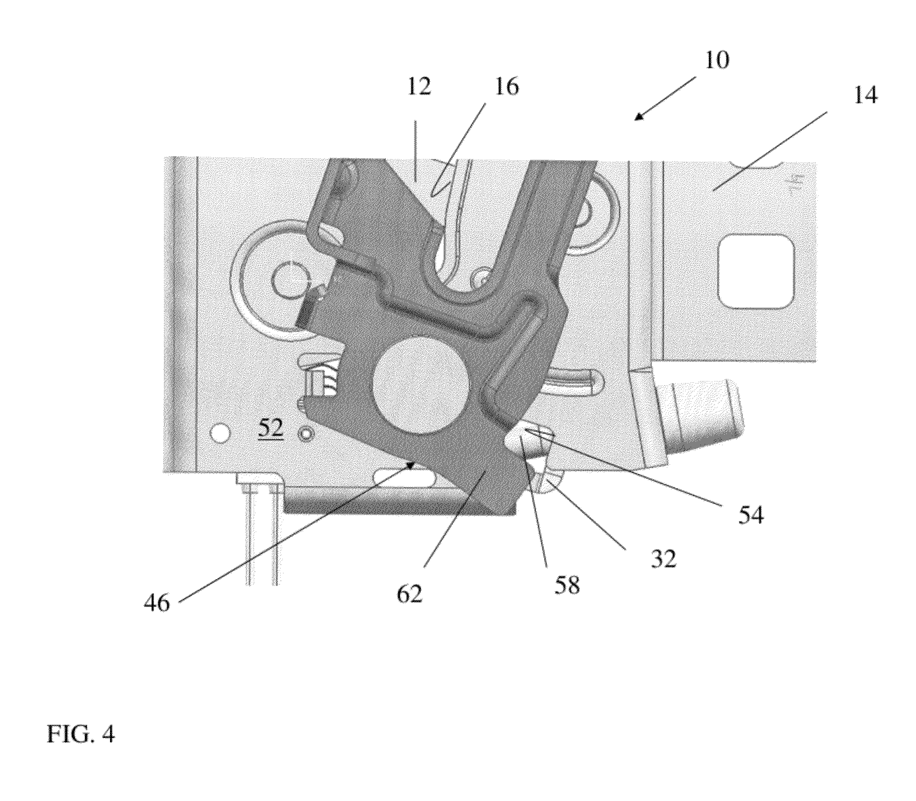

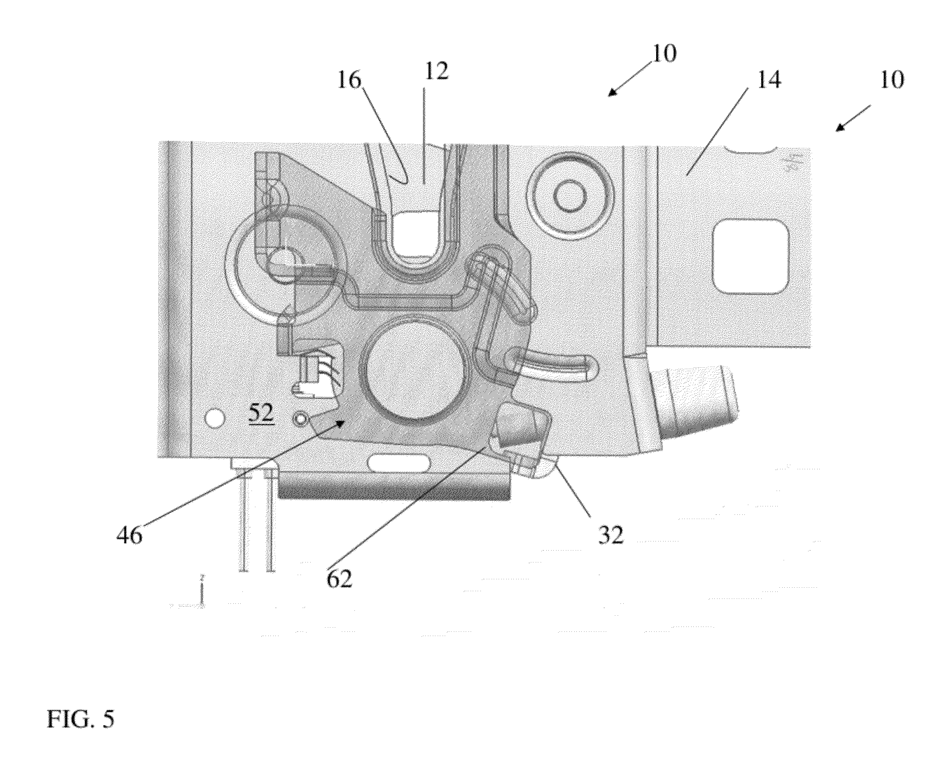

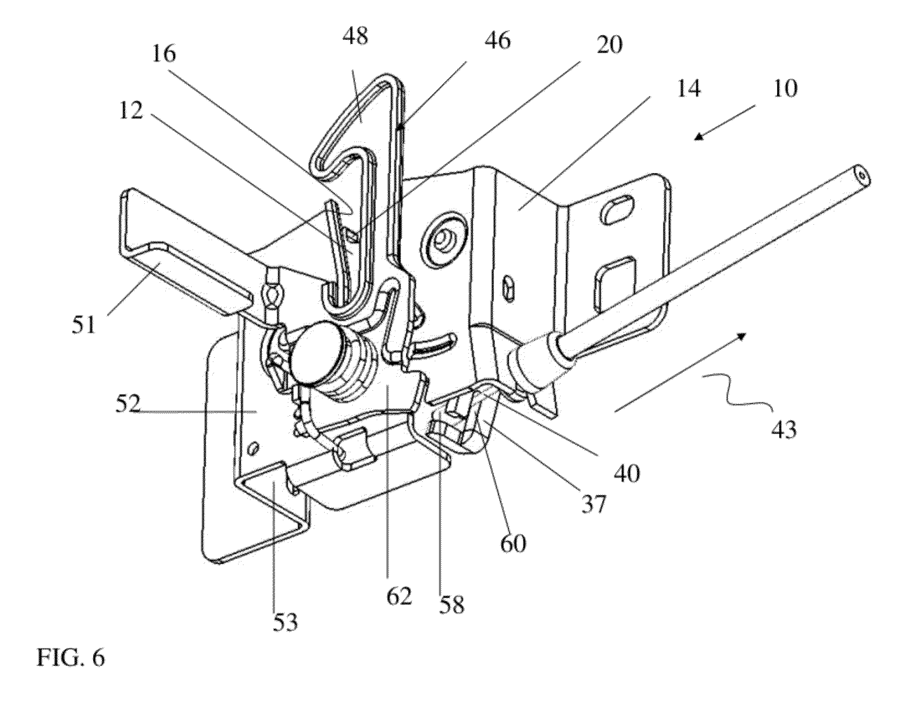

Referring now to FIGS. a latch assembly 10 in accordance with an exemplary embodiment of the present invention is illustrated. Latch assembly 10 has a fork bolt 12 pivotally or rotationally mounted to a housing or frame 14 for movement between a first open or unlatched position illustrated in FIGS. 1-4 and a second or latched position illustrated in FIGS. 5 and 6.

The frame has an opening 16 for receipt of a striker 18 therein. Similarly, the fork bolt has an opening 20 for receipt of the striker therein. In operation and as the striker moves in the direction of arrow 22 and when the fork bolt is in the open position (FIG. 1), the striker will engage and rotate or move the fork bolt in the direction of arrow 24 from the unlatched position (FIGS. 1-4) into the latched position (FIGS. 5 and 6). At this point, the striker is received and engaged in the both openings 16 and 20.

In order to retain the latch assembly or fork bolt in the latched position, a detent lever 32 is pivotally secured to the latch assembly for movement between an engaged position and a disengaged position. When the detent lever is in the engaged position, a surface of the fork bolt is engaged by a surface of the detent lever and the fork bolt is prevented from moving toward the unlatched position from the latched position. In one implementation, a first spring is provided for biasing the fork bolt in a direction opposite to arrow 24 and towards the unlatched position while a second spring is provided for biasing the detent lever in the direction of the engaged position, such that movement of the fork bolt to the latched position will cause the detent lever to move to the engaged position.

In accordance with exemplary embodiments of the present invention, the fork bolt has an engagement surface or contact surface that slides along and makes contact with a complimentary engagement surface or contact surface of the detent lever when the fork bolt pivots or moves from the open or unlatched position to the closed or latched position and once in the closed position a surface of the fork bolt engages a surface of the detent lever thus engaging the fork bolt and securing it into the closed position when the striker is secured in a receiving opening of the fork bolt. Once the latch is in the closed position the detent lever is spring biased into contact with the fork bolt such that the fork bolt cannot rotate into the open position unless the detent lever is moved back to the release or disengaged detent position.

In order to move the detent lever to the release or disengaged position a release cable 40 is coupled to the detent lever and the release cable is configured to move the detent lever from the engaged position to the disengaged position.

Accordingly and when the striker engages the fork bolt, the fork-bolt is pivoted downward to a latched position where the detent lever blocks the fork-bolt from being biased away from the striker opening to the unlatched position. When the cable is pulled in the direction of arrow 43, the detent lever is pivoted out of engagement with the fork bolt allowing the fork-bolt to move to the unlatched position.

As is known in the related arts the frame is adapted for fastening the latch assembly to a vehicle proximate to a compartment closure and the fork bolt or fork bolt lever is pivotally or rotationally mounted to frame plate about a pivot pin or stud that is received within a pivot pin opening of the fork bolt.

The latch assembly is attached to a vehicle structure such that the fork bolt is moved between the open position and the closed position when a hood, door, window, lift gate, etc. is opened and closed and the fork bolt engages a striker that is attached to the hood, door, window, lift gate, etc.

Alternatively, the latch assembly can be secured to the hood, door, window, lift gate, etc. and the striker is secured to the vehicle body at an opening into which the hood, door, window, lift gate, etc. is received.

The detent lever pivots on the frame plate about a pivot pin received within a pivot pin opening in the detent lever. The detent lever cooperates with the fork bolt in a well known manner to retain the fork bolt in the closed position or release the fork bolt for return to the open position. In accordance with an exemplary embodiment of the present invention, the fork bolt is spring biased to the open or unlatched position by a biasing member (e.g., coil spring or other equivalent member) that has one end attached to the fork bolt and the other end attached to the housing or other equivalent location. Similarly, a biasing member or spring will also bias the detent lever in the direction of a face of fork bolt. In addition, the secondary lever will also be spring biased into the first position.

The latch assembly also has a secondary lever 46 pivotally mounted to the latch assembly for movement between a first position (FIGS. 5 and 6) wherein a hasp 48 of the secondary lever is positioned over the striker opening and a second position wherein secondary lever is moved in the direction of arrow 24 and the hasp is no longer positioned over the striker opening such that the striker can be removed from the latch assembly. This is particularly advantageous when the latch assembly is a hood latch assembly and the striker is a hood striker secured to a hood 50 of a vehicle.

Accordingly, the hasp is configured to engage the striker when the striker is inserted in the striker opening and the secondary lever is in the first position. The secondary lever also has a handle portion 51 that extends away from an outer surface 52 of the frame. This handle portion allows a user to open the latch after the detent lever has been moved to the disengaged position by the release cable and the fork bolt rotates into the unlatched position. Thereafter, the user then must move the secondary lever from the first position to the second position in order to completely release the striker from the latch assembly. Moreover, movement of the secondary lever from the first position to the second position is prevented unless the fork bolt has been rotated into the unlatched position.

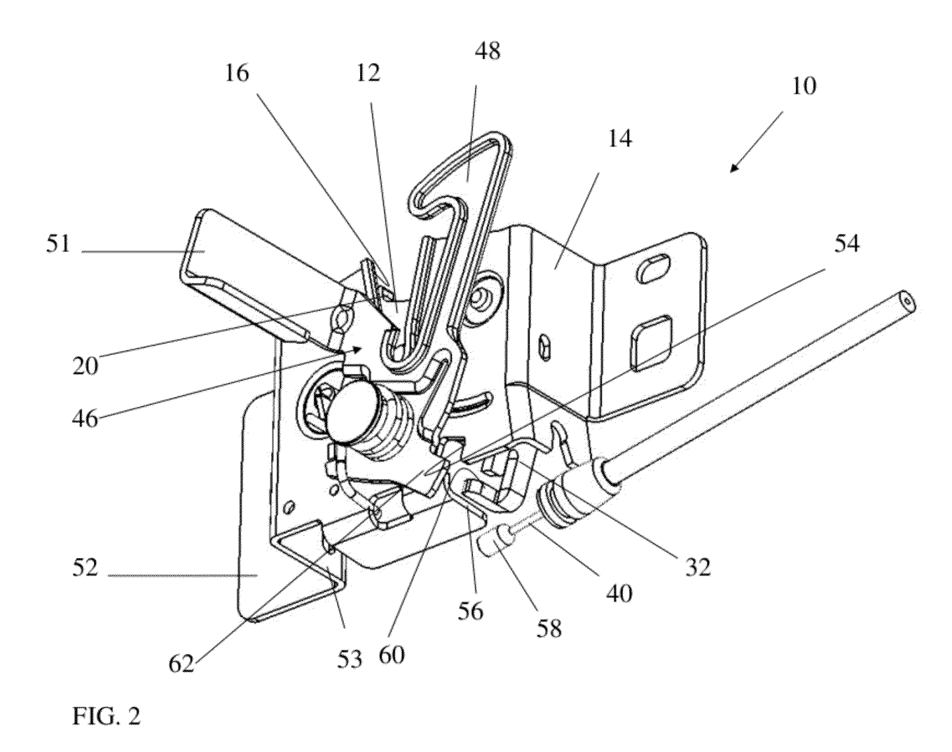

In some installation processes the latch assembly is first installed to the vehicle and then the release cable is secured to the detent lever. Accordingly, an inner surface 53 of the frame is secured to the vehicle structure and the opposite outer surface 52 of the frame is accessible. In order to secure the release cable to the detent lever after the frame has been secured to the vehicle, an access opening 54 must be provided in the frame. During this assembly process and referring at least to FIG. 2, the cable is inserted into a bottom opening 56 of the frame and then a cable end feature 58 is fitted into an opening 60 of the detent lever 32 by inserting a tool or other equivalent device into opening 54 in order to secure the cable end feature to the detent lever.

While opening 54 provides access for securing the release cable to the latch assembly after the frame has been secured to the vehicle the opening may still provide an access opening to the detent lever when a vehicle hood is closed since outer surface 52 is the surface that will face the front grill of the vehicle, which in some instances is not a completely sealed surface. Accordingly, it may be possible for an individual to manipulate the detent lever into the disengaged position by inserting a tool into the opening 54 thus simulating movement of the release cable in the direction of arrow 43 and thus providing access to the engine compartment or other vehicle compartment being secured by the latch assembly which, of course, would be a compromise in the security of the latch assembly. Obviously, opening 54 provides an unwanted access point to the detent lever after the latch assembly has been secured to the vehicle and the release cable has been attached to the detent lever.

In accordance with an exemplary embodiment of the present invention and in order to prevent access to the detent lever after the latch assembly has been installed while still also providing access to the detent lever to attach the release cable, a feature or extended tab portion 62 is provided on the secondary lever. As illustrated in the attached FIGS. feature or extended tab portion 62 is configured to block access opening 54 when the secondary lever is in the first position (FIGS. 5 and 6) and unblock opening 54 when it is in the second position (FIGS. 1-4). Thereafter, access opening 54 is only accessible from the outer surface when the secondary lever is moved to the second position, which can only occur when the fork bolt has been moved to the unlatched position. In other words, access to the detent lever via access opening 4 is only provided when the latch has been placed in an unlatched state, wherein the fork bolt is in the unlatched position.

In accordance with exemplary embodiments of the present invention, an apparatus and method of limiting access to a detent lever of a vehicle latch assembly is provided. In one non-limiting implementation, a latch assembly is provided and a fork bolt is pivotally secured a first side of the latch assembly for movement between an unlatched position and a latched position. In order to retain and subsequently, release the fork bolt a detent lever is pivotally secured the first side of the latch assembly for movement between an engaged position and a disengaged position, wherein the fork bolt is prevented from moving toward the unlatched position when the detent lever is in the engaged position.

On a second opposite side of the latch assembly, a secondary lever is pivotally secured to the latch assembly for movement between a first position, wherein a hasp of the secondary lever is positioned over a striker opening of the latch assembly and a second position wherein the hasp is not positioned over the striker opening. The secondary lever has a feature that blocks access to a first opening in the frame of the latch assembly when the secondary lever is in the first position and the feature of the secondary lever does not block access to the first opening when the secondary lever is in the second position.

In order to move the detent lever from the first position to the second position, a release cable is secured to the detent lever on the first side of the latch assembly by using the first opening when the secondary lever is in the second position. Thereafter and when the secondary lever is in the second position, access to the detent lever through the first opening is prevented by the feature of the secondary lever.

As used herein, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. In addition, it is noted that the terms “bottom” and “top” are used herein, unless otherwise noted, merely for convenience of description, and are not limited to any one position or spatial orientation.

The modifier “about” used in connection with a quantity is inclusive of the stated value and has the meaning dictated by the context (e.g., includes the degree of error associated with measurement of the particular quantity).

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A latch assembly, comprising:
a fork bolt pivotally secured to the latch assembly for movement between an unlatched position and a latched position;
a detent lever pivotally secured to the latch assembly for movement between an engaged position and a disengaged position, wherein the fork bolt is prevented from moving toward the unlatched position from the latched position when the detent lever is in the engaged position;
a frame, the frame having a striker opening and a first opening; and
a secondary lever pivotally mounted to the latch assembly for movement between a first position, wherein a hasp of the secondary lever is positioned over the striker opening and a second position wherein the hasp is not positioned over the striker opening and wherein a feature of the secondary lever blocks access to the first opening when the secondary lever is in the first position and wherein the feature of the secondary lever does not block access to the first opening when the secondary lever is in the second position.

2. The latch assembly as in claim 1, wherein the detent lever is coupled to a release cable on one side of the frame, the release cable being configured to move the detent lever from the engaged position to the disengaged position and the release cable being secured to a first portion of the detent lever, wherein the first opening is configured to allow access to the first portion of the detent lever from another side of the frame in order to couple the release cable to the detent lever.

3. The latch assembly as in claim 2, wherein movement of the secondary lever from the first position to the second position is prevented when the fork bolt is in the latched position.

4. The latch assembly as in claim 1, further comprising:
a first spring for biasing the fork bolt toward the unlatched position;
a second spring for biasing the detent lever into the engaged position; and
wherein movement of the secondary lever from the first position to the second position is prevented when the fork bolt is in the latched position.

5. The latch assembly as in claim 1, wherein the striker opening is located on an upper portion of the frame and the first opening is located on a lower portion of the frame below the striker opening.

6. The latch assembly as in claim 1, wherein the fork bolt has an opening configured to engage a striker when the striker is inserted into the striker opening and the fork bolt is in the unlatched position.

7. The latch assembly as in claim 6, wherein the hasp is configured to engage the striker when the striker is inserted in the striker opening and the secondary lever is in the first position.

8. The latch assembly as in claim 7, wherein the latch assembly is a hood latch assembly of a vehicle and the striker is secured to a hood of the vehicle and wherein the striker opening is located on an upper portion of the frame and the first opening is located on a lower portion of the frame below the striker opening.

9. The latch assembly as in claim 8, wherein the fork bolt, the secondary lever and the detent lever are pivotally mounted to the frame.

10. The latch assembly as in claim 1, wherein the fork bolt and the detent lever are pivotally mounted to a first side of the frame and the secondary lever is pivotally mounted to a second opposite side of the frame.

11. The latch assembly as in claim 10, wherein the detent lever is coupled to a release cable on the first side of the frame, the release cable being configured to move the detent lever from the engaged position to the disengaged position and the release cable being secured to a first portion of the detent lever, wherein the first opening is configured to allow access to the first portion of the detent lever from second opposite side of the frame in order to couple the release cable to the detent lever.

12. A hood latch assembly in combination with a hood striker, comprising:
a frame having a striker opening and a first opening formed therein;
a fork bolt pivotally secured to the latch assembly proximate to the striker opening for movement between an unlatched position and a latched position, the fork bolt having an opening configured to engage the hood striker when the hood striker is inserted into the striker opening and the fork bolt is in the unlatched position;
a detent lever pivotally secured to the latch assembly for movement between an engaged position and a disengaged position, wherein the fork bolt is prevented from moving toward the unlatched position from the latched position when the detent lever is in the engaged position, wherein the detent lever is coupled to a release cable, the release cable being configured to move the detent lever from the engaged position to the disengaged position; and
a secondary lever pivotally mounted to the latch assembly for movement between a first position, wherein a hasp of the secondary lever is positioned over the striker opening and a second position wherein the hasp is not positioned over the striker opening, wherein a feature of the secondary lever blocks access to the first opening when the secondary lever is in the first position and wherein the feature of the secondary lever does not block access to the first opening when the secondary lever is in the second position.

13. The latch assembly as in claim 12, wherein the detent lever is coupled to a release cable on one side of the frame, the release cable being configured to move the detent lever from the engaged position to the disengaged position and the release cable being secured to a first portion of the detent lever, wherein the first opening is configured to allow access to the first portion of the detent lever from another side of the frame in order to couple the release cable to the detent lever.

14. The latch assembly as in claim 12, wherein movement of the secondary lever from the first position to the second position is prevented when the fork bolt is in the latched position.

15. The latch assembly as in claim 12, wherein the striker opening is located on an upper portion of the frame and the first opening is located on a lower portion of the frame below the striker opening.

16. The latch assembly as in claim 12, wherein the fork bolt and the detent lever are pivotally mounted to a first side of the frame and the secondary lever is pivotally mounted to a second opposite side of the frame.

17. A method of limiting access to a detent lever of a vehicle latch assembly, the method comprising:
pivotally securing a fork bolt to a first side of a frame of the latch assembly for movement between an unlatched position and a latched position;
pivotally securing a detent lever to the first side of the frame of the latch assembly for movement between an engaged position and a disengaged position, wherein the fork bolt is prevented from moving toward the unlatched position when the detent lever is in the engaged position;
pivotally securing a secondary lever to a second opposite side of the frame of the latch assembly for movement between a first position, wherein a hasp of the secondary lever is positioned over a striker opening of the latch assembly and a second position wherein the hasp is not positioned over the striker opening, wherein a feature of the secondary lever blocks access to a first opening when the secondary lever is in the first position and wherein the feature of the secondary lever does not block access to the first opening when the secondary lever is in the second position; and
securing a release cable to the detent lever on the first side of the latch assembly by using the first opening when the secondary lever is in the second position.

18. The method as in claim 17, wherein the release cable is configured to move the detent lever from the engaged position to the disengaged position.

19. The method as in claim 17, wherein movement of the secondary lever from the first position to the second position is prevented when the fork bolt is in the latched position.

20. The method as in claim 17, wherein the striker opening is located on an upper portion of the frame and the first opening is located on a lower portion of the frame below the striker opening.
